(19) United States
(12) Patent Application Publication
(10) Pub. No.: US 2005/0034016 A1
(43) Pub. Date: Feb. 10, 2005

(54) Microcontroller with logic protection against electrostatic discharges

(75) Inventors: Olivier Ferrand, Puyloubier (FR); Dragos Davidescu, Aix en Provence (FR)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: STMICROELECTRONICS S.A., MONTROUGE (FR)

(21) Appl. No.: 10/884,380

(22) Filed: Jul. 2, 2004

(30) Foreign Application Priority Data
Jul. 2, 2003 (FR) 03 08053

(51) Int. Cl. H04L 1/22

(52) U.S. Cl. 714/23

(57) ABSTRACT

A microcontroller includes a microprocessor (2), a reset circuit (3) selectively generating a signal for resetting the microprocessor (2), and a detection device (4), having at least one input for receiving (5) a vital logic signal from the microcontroller and an output (6) applying a reset command to the reset circuit upon detecting a change in the logic state of the vital logic signal. A computer system can include one or more of the microcontroller.

### CROSS-REFERENCE TO RELATED APPLICATION

This application is based upon and claims priority from prior French Patent Application No. 03 08053, filed on Jul. 2, 2003, the entire disclosure of which is herein incorporated by reference.

### BACKGROUND OF THE INVENTION

1. Field of the Invention

The invention relates to microcontroller protection against electrostatic discharges (also called ESD for electrostatic discharge) and notably to a microcontroller having a protection against functional electrostatic discharges. An electrostatic discharge which changes the logic operation of a module of the microcontroller is designated as functional electrostatic discharge.

2. Description of the Related Art

The use of microcontrollers comprising contact plates for exchanging signals with the outside world, and comprising functional modules connected to the contact plates, is known in the state of the art. The functional modules comprise components, such as transistors, likely to be deteriorated upon applying electrostatic discharges on the contact plates. An operator may notably behave electrically like a charged condenser with about 5 kV and apply an electrical pulse during a few tens of nanoseconds.

There are two types of protection for a microcontroller. The physical protection uses integrated circuits at the input/output ports of the modules of the microcontroller. These circuits dissipate electrostatic discharges and avoid destruction of the modules. These protection circuits conventionally comprise two diodes. A diode is connected in series between the output contact plate and a power supply line VDD of the functional module. Moreover, the other diode is connected in series between the output contact plate and a ground line. When the voltage applied on the contact plate is larger than the sum of the VDD voltage and the threshold voltage of the corresponding diode, the diode is conducting from the contact plate to the power supply line. The diode therefore short-circuits the positive discharges applied to the contact plate. Similarly, when the voltage of the ground line is larger than the sum of the contact plate's voltage and of the threshold voltage of the corresponding diode, the diode is conducting from the ground line to the contact plate. Therefore, the diode short-circuits negative discharges applied to the contact plate.

This type of protection proves to be insufficient for guaranteeing proper logic operation or automatic resuming of the logic operation in the microcontroller. The logic protection consists in protecting the microcontroller against functional electrostatic discharges. Conventionally, this protection is achieved by a circuit of the microcontroller detecting an illegal logic instruction in the microprocessor and generating a reset of the whole microcontroller upon such detection.

However, such a circuit only detects a reduced proportion of the existing electrostatic discharges. Thus, the detector does not take into account the failures of functional modules which do not involve the generation of an illegal logic instruction.

Accordingly, there exists a need for overcoming the disadvantages of the prior art as discussed above.

### SUMMARY OF THE INVENTION

Therefore, there is a need which the invention is directed to meet, for a microcontroller solving these drawbacks. The invention, according to one embodiment, thus relates to a microcontroller comprising:

a microprocessor;

a circuit for resetting the microprocessor, selectively generating a signal for resetting the microprocessor; and

a detection device, having at least one input for receiving a vital logic signal from the microcontroller, and an output applying a reset command to the resetting circuit upon detecting a change in logic state of the vital signal.

The detection device comprises a D flip-flop having a D input supplied with a stationary signal, a clock input receiving the inverted vital signal, a reset input receiving the reset signal emitted by the reset circuit, and an output forming the output of the device.

According to a further alternative, the detection device comprises an OR gate having several inputs receiving respective vital signals and an output connected to the clock input of the D flip-flop.

According to another alternative, the microcontroller further comprises a clock for monitoring the operation of the microprocessor, generating a vital signal applied at the input of the detection device the logic state of which is changed upon a time out.

According to still another alternative, the microcontroller further comprises logic modules connected to the microprocessor and reset by said reset signal.

According to one alternative, a vital signal received by the detection circuit is a reset signal generated by a logic module.

It may still be provided that the microcontroller further comprises:

at least one module for detecting illegal instructions of the microprocessor, selectively generating an error signal on its output; and

an OR gate having an input connected to the output of the detection device, and at least one input connected to the output of the module for detecting illegal instructions.

### BRIEF DESCRIPTION OF THE DRAWINGS

The invention will be better understood upon reading the description which follows and examining the appended figures.

FIG. 1 shows a schematic representation of an exemplary microcontroller according to the invention;

FIG. 2 shows a time diagram illustrating the operation of a D flip-flop used in the microcontroller of FIG. 1.

### DETAILED DESCRIPTION

The invention proposes detecting the failure of the microcontroller by monitoring its vital signals. In the following, a signal which should remain stationary during normal use, in the absence of any reset command, will be designated as a vital signal of a microcontroller, a vital signal further being distinct from a signal for detecting an illegal instruction.

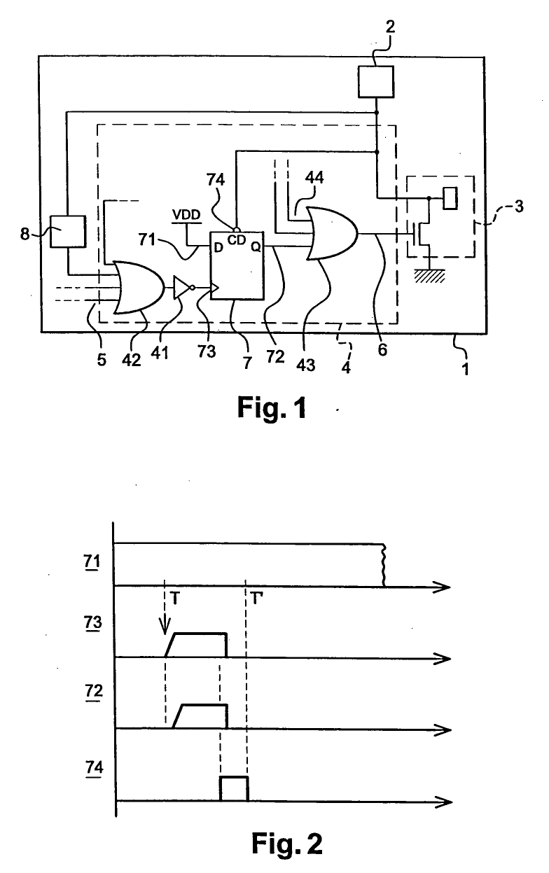

FIG. 1 schematically represents an exemplary microcontroller according to the invention. Such a microcontroller 1 comprises a microprocessor 2, a reset circuit 3 for resetting the microprocessor selectively generating a signal for resetting the microprocessor. The microcontroller 1 further comprises a detection device 4, having at least one input 5 for receiving a vital logic signal from the microcontroller, and an output 6 applying a reset command to the reset circuit 3 upon detecting a change in logic state of the vital logic signal.

A state change of a vital logic signal at input 5 is thereby detected by the detection device 4, which generates a reset command applied to the reset circuit 3. The reset circuit 3 then resets the adequate parts of the microcontroller 1. It may notably be provided that the reset circuit 3 resets the microprocessor 2 as well as the different functional modules of the microcontroller 1.

Microcontroller 1 thus has increased protection against electrostatic discharges and is automatically reset by circuit 3 for an increased range of possible failures.

In the illustrated example, the detection device comprises a type D flip-flop, identified by reference 7. This flip-flop 7 has a referenced D input 71, supplied with a stationary VDD signal, a clock input 73 receiving the inverted vital signal from input 5, a reset input 74 receiving the reset signal emitted by the reset circuit 3, and an output 72 forming the output of device 4. As illustrated, the input vital signal is inverted by a NOT gate 41.

Of course, the inversion on the clock input is only optional and depends on the normal state of the reset signal. For a vital signal at logic level 0 during normal operation, the inversion is thereby avoided, in order to obtain a rising front on the clock input 73.

FIG. 2 illustrates a time diagram of the operation of the microcontroller of FIG. 1. The numbers in the left margin correspond to the references of the D flip-flop terminals. Input 71 is supplied with the stationary Vdd voltage. The vital signal is at high logic level during normal operation. The logic level on input 73 therefore is in the low state initially, because of the NOT gate. The logic level on output 72 is in the low state initially. In the absence of any change in the state on input 73, the high logic level of input 71 is not recopied on output 72.

At instant T, a vital signal undergoes a change in state, identified by a rising front on the clock input 73. Output 72 thus passes into the high state with a slight delay because of this rising clock front. The transition to the high state of output 72 forms a reset command applied on circuit 3. Circuit 3 then generates with a certain delay a reset signal applied on input 74. Moreover, the reset signal is applied to other modules of the microcontroller, the vital signal changes to the high state; the signal on the gate 73 therefore passes to the low state. Thus, at instant T′, the D flip-flop is operational for detecting a new state change of the vital signal.

Advantageously, the illustrated detection device 4 comprises an OR gate 42 having several inputs forming the input of device 4. The inputs of the OR gate receive respective vital signals. The output of the OR gate 42 is connected to the clock input of the D flip-flop (in this case, via the NOT gate 41). With the OR gate 42, several vital signals of a microcontroller 1 may be processed with a same detection circuit 4.

The vital signals may for example, be internal reset signals of one or more functional modules 8 of the microcontroller 1, or a time-out signal generated by a monitoring clock of the microprocessor.

It may thus be provided that logic modules 8 are connected to the microprocessor 2 and reset by the signal for resetting the circuit 3.

It may also be provided that the microcontroller comprises a clock for monitoring the operation of the microprocessor generating a vital signal applied at the input of the detection device. The logic state of this vital signal is changed upon time-out of the monitoring clock.

Advantageously, as is known per se, the microprocessor has a module for detecting illegal instructions, received by the microprocessor 2 for example. This module selectively generates one or more illegal instruction signals on its output. These illegal instruction signals in the example are applied to the inputs 44 of an OR gate 43. This OR gate 43 has an additional input connected to the output of the detection device or of the flip-flop 7. The output of the OR gate 44 is applied to the input of the reset circuit. Thus, with the microcontroller 1 according to the invention, a reset command may also be generated for the illegal instruction signals from a same reset circuit 3.

While there has been illustrated and described what is presently considered to be embodiments of the present invention, it will be understood by those of ordinary skill in the art that various other modifications may be made, and equivalents may be substituted, without departing from the true scope of the present invention.

Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

1. A microcontroller, comprising:
a microprocessor;
a circuit for resetting the microprocessor, selectively generating a signal for resetting the microprocessor; and
a detection device, having at least one input for receiving a vital logic signal from the microcontroller, and an output applying a reset command on the reset circuit upon detecting a change in logic state of the vital signal; and
wherein:
the detection device comprises a D flip-flop, having a D input supplied with a stationary signal, a clock input receiving the vital signal, a reset input receiving the reset signal emitted by the reset circuit, and an output forming the output of the device.

2. The microcontroller according to claim 1, wherein the detection device comprises an OR gate having several inputs receiving respective vital signals and an output connected to the clock input of the D flip-flop.

3. The microcontroller according to claim 1, further comprising a clock for monitoring the operation of the microprocessor generating a vital signal applied at the input of the detection device, the logic state of which is changed upon a time-out.

4. The microcontroller according to claim 1, further comprising logic modules connected to the microprocessor and reset by said reset signal.

5. The microcontroller according to claim 4, wherein a vital signal received by the detection circuit is a reset signal generated by a logic module.

6. The microcontroller according to claim 1, further comprising:
at least one module for detecting illegal instructions of the microprocessor selectively generating an error signal on its output; and
an OR gate having an input connected to the output of the detection device and at least one input connected to the output of the module for detecting illegal instructions.

7. A computer system comprising:
a plurality of microcontrollers, at least on of the plurality of microcontrollers comprising:
a microprocessor;
a circuit for resetting the microprocessor, selectively generating a signal for resetting the microprocessor; and
a detection device, having at least one input for receiving a vital logic signal from the microcontroller, and an output applying a reset command on the reset circuit upon detecting a change in logic state of the vital signal; and wherein:
the detection device comprises a D flip-flop, having a D input supplied with a stationary signal, a clock input receiving the vital signal, a reset input receiving the reset signal emitted by the reset circuit, and an output forming the output of the device.

8. The computer system of claim 7, wherein the detection device comprises an OR gate having several inputs receiving respective vital signals and an output connected to the clock input of the D flip-flop.

9. The computer system of claim 7, further comprising a clock for monitoring the operation of the microprocessor generating a vital signal applied at the input of the detection device, the logic state of which is changed upon a time-out.

10. The computer system of claim 7, further comprising logic modules connected to the microprocessor and reset by said reset signal.

11. The computer system of claim 7, wherein a vital signal received by the detection circuit is a reset signal generated by a logic module.

12. The computer system of claim 7, further comprising:
at least one module for detecting illegal instructions of the microprocessor selectively generating an error signal on its output; and
an OR gate having an input connected to the output of the detection device and at least one input connected to the output of the module for detecting illegal instructions.
